(19) United States
(12) Patent Application Publication
(10) Pub. No.: US 2026/0368671 A1
(43) Pub. Date: Nov. 19, 2026

(54) INTELLIGENT SIGNING SYSTEM AND INTELLIGENT SIGNING METHOD

(71) Applicant: TWAI Inc., Grand Cayman (KY)

(72) Inventor: CHE-MIN CHUNG, Kaohsiung City (TW)

(21) Appl. No.: 19/651,818

(22) Filed: Apr. 20, 2026

Related U.S. Application Data
(60) Provisional application No. 63/790,719, filed on Apr. 18, 2025.
(60) Provisional application No. 63/790,720, filed on Apr. 18, 2025.

(51) Int. Cl. G06Q 10/0635; G06Q 50/18

(52) U.S. Cl. CPC G06Q 10/0635; G06Q 50/18

(57) ABSTRACT

An intelligent signing system and method includes a task assignment device, a first server, a second server, a database server, and a first client device. The first server receives a document to be signed and a signing task request. The second server initiates an intelligent risk assessment engine and, based on an assessment parameter corresponding to a specific approval role in the signing task request, performs a risk assessment analysis on the document to be signed, so as to generate a risk assessment report. The first server provides the report together with the document to be signed to the first client device for display, so as to assist in generating a first signature object and a first approval comment. The present invention can automate multi-tier risk assessment, reduce the review burden, and improve decision-making efficiency.

### CROSS-REFERENCE TO RELATED APPLICATIONS

This application claims priority to and the benefit of U.S. Provisional Application Ser. No. 63/790,719 and U.S. Provisional Application Ser. No. 63/790,720, both filed on Apr. 18, 2025, the disclosures of all of which are incorporated herein by reference in their entireties.

### FIELD

The present invention relates to a technology for data analysis, and more particularly, to an intelligent signing system and an intelligent signing method that utilize artificial intelligence to perform analysis and provide recommendations by means of document parsing and data analysis.

### BACKGROUND

When an enterprise conducts procurement, financial decision-making, or legal review, it typically must go through a multi-tier online signing and approval process. Conventional electronic signature systems or workflow management software are generally limited in function to digitizing paper documents and simply transmitting a document to be signed in sequence to the client devices of various departments according to a preset static path. Under such a conventional architecture, the approving personnel at each approval node must rely heavily on their own professional knowledge, manually reading complex contract content word by word and manually retrieving historical data, in order to complete the review work.

However, this operational mode, which is highly dependent on manual review, causes the overall approval time to be highly dependent on the individual review progress of each department, which not only makes the decision-making time difficult to accurately predict, but also frequently and severely affects the advancement of an enterprise's business plans due to delays in the process. In addition to the low review efficiency, conventional signing systems also have significant technical deficiencies in risk control and data integration. Existing review mechanisms rely primarily on manual judgment and lack an intelligent risk assessment capability, which makes it easy for reviewing personnel, when processing a large amount of information, to produce an insufficiently comprehensive risk assessment, or even overlook potential risks hidden in a contract, due to insufficient information or human oversight.

Furthermore, although a modern enterprise typically has already established various heterogeneous database systems internally, such as an Enterprise Resource Planning (ERP) system, a Customer Relationship Management (CRM) system, and finance and procurement systems, the data within these systems often exists in the form of data silos and fails to be substantively linked with the contract approval process. This causes an approver, when facing a signing decision, to be unable to refer in real time to the enterprise's internal historical transaction records, nor to compare external market fluctuation data, such that the basis for the signing decision is rather weak.

Moreover, conventional systems lack an automated computational capability for performing qualitative semantic analysis on contract text and quantitative financial simulation on associated data. For most small and medium-sized enterprises, hiring a dedicated legal or procurement analyst with deep professional knowledge to vet contracts constitutes a heavy operating cost.

When a conventional system is faced with a document to be signed that carries a high risk, it can only passively provide a single approve-or-return operation, being unable to proactively flag risk clauses, and even less able to dynamically generate, for different approval roles, specific decision recommendations such as modifying payment terms or re-evaluating a supplier. Accordingly, there is a pressing need in the industry for a novel online signing architecture capable of automatically integrating multi-party data, performing an in-depth risk assessment, and reducing the manual review burden through intelligent assistance, so as to overcome the limitations of existing technology in review accuracy and operational risk control.

### SUMMARY

It is an object of one preferred embodiment of the present invention to provide an intelligent signing system and an intelligent signing method that utilize a data-analyzing model to analyze internal data and external data and provide recommendations, so as to enable a decision-maker to assess risk and thereby determine whether to sign.

In view of the foregoing, a preferred embodiment of the present invention provides an intelligent signing system. The intelligent signing system includes a task assignment device and at least one server. The task assignment device is configured to provide a document to be signed and generate a signing task request according to the document to be signed. The at least one server stores a first user account and a first assessment parameter associated with the first user account and is configured to: receive the signing task request from the task assignment device; execute, in response to the signing task request, an artificial intelligence risk assessment model and perform a first risk assessment analysis on the document to be signed based on the first assessment parameter, so as to generate a first risk assessment report corresponding to the first user account; generate, according to the signing task request, at least one signing task interface and record the document to be signed and the first risk assessment report on the at least one signing task interface; provide the at least one signing task interface, on which the document to be signed and the first risk assessment report are recorded, to a first client device associated with the first user account; receive a first signing completion message from the first client device; and record, in response to receiving the first signing completion message, a first signature object and a first approval comment generated by the first client device on the at least one signing task interface, so as to generate at least one updated signing task interface.

Another preferred embodiment of the present invention provides an intelligent signing method. The intelligent signing method includes: providing, via a task assignment device, a document to be signed and generating a signing task request according to the document to be signed; and executing, via at least one server, the following steps: executing, in response to the signing task request, an artificial intelligence risk assessment model and performing a first risk assessment analysis on the document to be signed based on a first assessment parameter, so as to generate a first risk assessment report corresponding to a first user account; generating, according to the signing task request, at least one signing task interface and recording the document to be signed and the first risk assessment report on the at least one signing task interface; providing the at least one signing task interface, on which the document to be signed and the first risk assessment report are recorded, to a first client device associated with the first user account; receiving a first signing completion message from the first client device; and recording, in response to receiving the first signing completion message, a first signature object and a first approval comment generated by the first client device on the at least one signing task interface, so as to generate at least one updated signing task interface.

In summary, a preferred embodiment of the present invention adopts a multi-tier intelligent signing system that integrates qualitative analysis via a natural language processing model with quantitative simulation via a machine learning model. By automatically linking heterogeneous databases internal and external to the enterprise, and introducing a Retrieval-Augmented Generation technique to precisely compare historical contract characteristics with market data, and dynamically configuring dedicated assessment parameters for different reviewing departments, the system is able to, during the contract review process, automatically and comprehensively detect legal loopholes and financial cash-flow anomalies hidden within a document to be signed, and in turn generate, in real time, a risk assessment report and decision recommendations including specific operational options (such as directly signing, modifying terms, or returning the document). This significantly reduces the review burden on professionals such as legal, finance, and procurement personnel, and, through precise decision-assistance options, effectively improves the overall accuracy and execution efficiency of the approval process, thereby constructing, for the enterprise, a decision management architecture with low operational risk and a high degree of defensibility.

In order to make the above and other objects, features, and advantages of the present invention more apparent, preferred embodiments are described in detail below with reference to the accompanying drawings.

### BRIEF DESCRIPTION OF THE DRAWINGS

FIG. 1 is a block diagram of an intelligent signing system according to an embodiment of the present invention.

FIG. 2 is a schematic diagram illustrating intelligent signing task assignment and system architecture according to an embodiment of the present invention.

FIGS. 3A to 3G are flowcharts of an intelligent signing method according to a preferred embodiment of the present invention.

FIG. 4 is a sequence diagram of an intelligent signing method according to a preferred embodiment of the present invention.

FIG. 5 is a schematic diagram illustrating the interface architecture of a signing task interface according to a preferred embodiment of the present invention.

### DETAILED DESCRIPTION OF PREFERRED EMBODIMENTS

The following description contains specific information pertaining to exemplary embodiments in the present invention. The drawings and their accompanying detailed description in the present invention are directed to exemplary embodiments only. However, the present invention is not limited to such exemplary embodiments. Other variations and embodiments of the present invention will occur to those skilled in the art. Unless otherwise specified, identical or corresponding elements in the drawings may be indicated by identical or corresponding reference numerals. Moreover, the drawings and illustrations in the present invention are generally not drawn to scale and are not intended to correspond to actual relative dimensions.

For the purpose of consistency and ease of understanding, identical features are identified by reference numerals in the exemplary drawings, although in some instances they may not be so labeled. However, features in different embodiments may differ in other respects and thus shall not be narrowly construed as being confined to the features shown in the drawings.

References to “at least one embodiment,” “an embodiment,” “embodiments,” “different embodiments,” “some embodiments,” “the present embodiment,” and similar terms may indicate that the embodiment(s) of the invention so described may include a particular feature, structure, or characteristic, but not every possible embodiment of the invention necessarily includes the particular feature, structure, or characteristic. In addition, repeated use of the phrases “in an embodiment” or “in the present embodiment” does not necessarily refer to the same embodiment, although they may. Furthermore, phrases such as “embodiment” used in connection with “the present invention” do not imply that all embodiments of the present invention must include the particular feature, structure, or characteristic, and should be understood as meaning “in at least some embodiments of the present invention” including the particular feature, structure, or characteristic described. The term “coupled” is defined as connected, whether directly or indirectly through intervening elements, and is not necessarily limited to a physical connection. When the term “comprising” is used, it means “including but not limited to,” which expressly indicates an open-ended inclusion or relationship of the stated combination, group, series, and equivalents thereof.

Additionally, for purposes of explanation and non-limitation, specific details such as functional entities, techniques, protocols, standards, and the like are set forth to provide an understanding of the described technology. In other instances, detailed descriptions of well-known methods, techniques, systems, architectures, and the like are omitted to avoid unnecessarily obscuring the description with unnecessary detail.

The terms “first,” “second,” and “third” and the like used in the specification of the present invention and in the aforementioned drawings are used to distinguish between different objects, rather than to describe a specific order. In addition, the term “comprising” and any variations thereof are intended to cover a non-exclusive inclusion. For example, a process, method, system, product, or apparatus that includes a series of steps or modules is not limited to the listed steps or modules, but may optionally further include steps or modules not listed, or may optionally further include other steps or modules inherent to such processes, methods, products, or apparatuses.

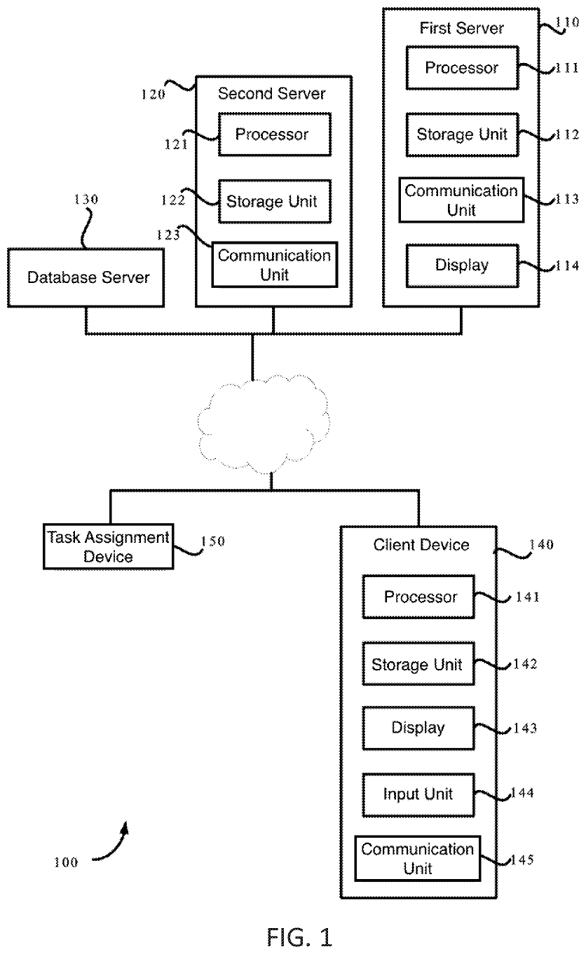

FIG. 1 is a block diagram of an intelligent signing system according to an embodiment of the present invention. Referring to FIG. 1, the intelligent signing system 100 includes a first server 110, a second server 120, a database server 130, a client device 140, and a task assignment device 150. The first server 110, the second server 120, and the database server 130 may be independent cloud servers or may be integrated into the same server or two or more servers to jointly serve as the computing devices and storage database of the intelligent signing system 100. Here, the first server 110, the second server 120, the database server 130, the client device 140, and the task assignment device 150 each have a communication module or can be connected via a network and can communicate via wired or wireless transmission to send and receive signals and data to and from one another.

The database server 130 is, for example, a server that provides an object storage service, and is used to store an assigned document. The assigned document may be any document that requires signing. In an embodiment, the database server 130 employs Amazon Simple Storage Service, and is configured to store and protect any amount of data suitable for various use cases, such as a data lake, a website, a mobile application, backup and restoration, archiving, an enterprise application, an Internet of Things (IoT) device, and big data analytics.

The task assignment device 150 is configured to provide a document to be signed and generate a signing task request according to the document to be signed. The first server 110 and the second server 120 may provide the functionality of computing devices. The first server 110 is configured to receive the signing task request from the task assignment device 150 and generate a signing request based on the signing task request. The first server 110 and the second server 120 are electronic devices or servers having computing and networking capabilities. For example, the first server 110 includes at least a processor 111, a storage unit 112, a communication unit 113, and a display 114. The processor 111 is coupled to the storage unit 112, the communication unit 113, and the display 114. The second server 120 includes at least a processor 121, a storage unit 122, and a communication unit 123. The processor 121 is coupled to the storage unit 122 and the communication unit 123.

The client device 140 is an electronic device used by a signer who is assigned to perform a signing action. For example, the client device 140 may be implemented using a personal computer, a laptop computer, a tablet computer, or a smartphone. The client device 140 includes at least a processor 141, a storage unit 142, a display 143, an input unit 144, and a communication unit 145. The processor 141 is coupled to the storage unit 142, the display 143, the input unit 144, and the communication unit 145.

The processors 111, 121, 141 are, for example, a Central Processing Unit (CPU), a Physics Processing Unit (PPU), a programmable microprocessor, an embedded control chip, a Digital Signal Processor (DSP), an Application Specific Integrated Circuit (ASIC), or another similar device.

The storage units 112, 122, 142 are, for example, any type of fixed or removable Random Access Memory (RAM), Read-Only Memory (ROM), flash memory, hard disk, or other similar device, or a combination of such devices. In the first server 110 and the second server 120, the storage units 112, 122 each include one or more program code segments, which, after being installed, are executed by the corresponding processor 111, 121. In addition, in the client device 140, the storage unit 142 includes one or more program code segments, which, after being installed, are executed by the processor 141.

The communication units 113, 123, 145 may be chips or circuits employing Local Area Network (LAN) technology, Wireless LAN (WLAN) technology, or mobile communication technology. An example of a local area network is Ethernet. An example of a wireless local area network is Wi-Fi. Examples of mobile communication technology include the Global System for Mobile Communications (GSM), third-generation mobile communication technology (3G), fourth-generation mobile communication technology (4G), fifth-generation mobile communication technology (5G), and the like.

The displays 114, 143 are, for example, a Liquid Crystal Display (LCD), a Plasma Display, or the like. The input unit 144 is, for example, a writing tablet or a touch panel, used to receive a handwriting trace. Alternatively, the input unit 144 may also be an image capturing device, used to capture an image file of a seal or a handwritten signature. The image capturing device is, for example, a camera employing a Charge Coupled Device (CCD) lens or a Complementary Metal Oxide Semiconductor (CMOS) lens, or the like.

The hardware architecture of the database server 130 is likewise designed, similarly to the first server 110, to include a processor, a storage unit, and a communication unit. In an embodiment, the database server 130 and the first server 110 may be implemented by the same electronic device. The hardware architecture of the task assignment device 150 is similar to that of the client device 140 and is used to provide a task creator with a means of generating the signing task request. In an embodiment, the client device 140 and the task assignment device 150 may be set to be implemented by the same electronic device. That is, when the electronic device is used by the task creator, the electronic device serves as the task assignment device 150; when the electronic device is used by the signer, the electronic device serves as the client device 140. In another embodiment, the client device 140 and the task assignment device 150 may also be implemented by two separate electronic devices.

The first server 110, the second server 120, the database server 130, the client device 140, and the task assignment device 150 each store, in their respective storage units, one or more program code segments, and execute the corresponding functions via their respective processors.

In the client device 140, after receiving a signing request from the first server 110, the communication unit 145 of the client device 140 transmits a login request to the first server 110. After the first server 110 receives the login request, the processor 111 of the first server 110 provides a signing task interface in response to the login request. The display 143 of the client device 140 displays the signing task interface, for signing the document to be signed and/or generating an approval comment. Next, an embodiment is provided to describe the process of generating a signing task request via a task assignment device.

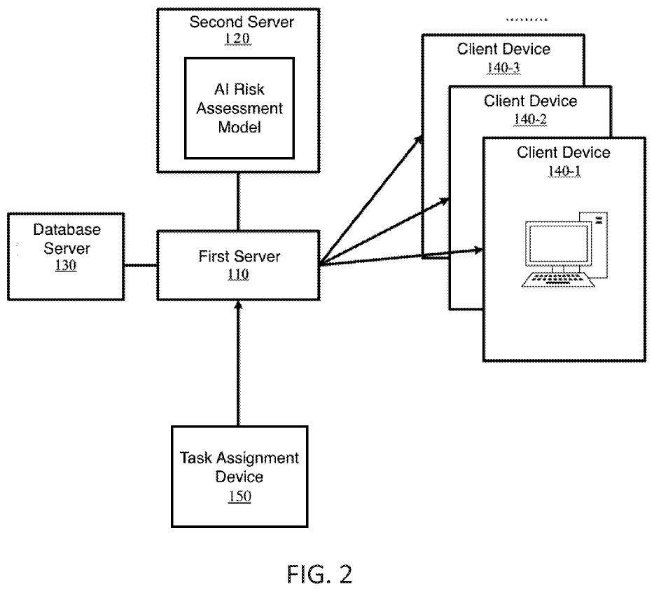

FIG. 2 is a schematic diagram illustrating intelligent signing task assignment and system architecture according to an embodiment of the present invention. In this embodiment, a plurality of signers (i.e., specific approval roles) are used as an example for description, assuming that different signers use different client devices 140-1 to 140-3. Here, the client devices 140-1 to 140-3 have the same function and architecture as the first client device and the second client device in the foregoing embodiments and generically refer to any one of the client devices 140-1 to 140-3. In an embodiment, the client devices 140-1 to 140-3 may be implemented using different electronic devices, corresponding to different specific approval roles (for example, procurement department personnel, finance department personnel, or legal department personnel). In another embodiment, a plurality of signers may also use the same electronic device to implement different client device logins.

In FIG. 2, a task creator provides a document to be signed via the task assignment device 210, generates a signing task request according to the document to be signed, and transmits the signing task request to the first server 110. In an embodiment, the signing task request may include storage location information associated with the document to be signed, and the first server 110 may download the document to be signed from the database server 130 according to the storage location information. In another embodiment, the assignment device 210 may transmit the document to be signed to the first server 110. The task assignment device 210 is, for example, a laptop computer of a sales representative, an office desktop computer of a procurement specialist, an internal Enterprise Resource Planning (ERP) system server of the enterprise, or the like.

After the first server 110 receives the document to be signed, it triggers the artificial intelligence risk assessment model in the second server 120 based on the signing task request. The second server 120 obtains the document to be signed and the corresponding assessment parameter from the database server 130 and performs a risk assessment analysis on the document to be signed so as to generate a risk assessment report, and subsequently transmits the report to the first server 110. Next, the first server 110 receives the risk assessment report, and, according to a set signing sequence, transmits a signing request in sequence to the client devices 140-1 to 140-3 corresponding to the respective signers. Here, the first server 110 is set such that, only after obtaining the signed document from the previous tier, will it continue to transmit the signing request of the next signer to the corresponding client device.

The task assignment device 210 is used to designate the document to be signed and the signer settings. That is, the task creator uses the task assignment device 210 to designate a document requiring risk assessment and review as the document to be signed and performs signer settings to determine which specific approval role(s) (one or more signers) are the signers.

In an embodiment, the task assignment device 210 may first connect to a task creation interface provided by the first server 110 and upload the document to be signed to the first server 110 and forward it for storage at the database server 130. The database server 130 classifies and archives the document to be signed to generate document association information associated therewith (for example, a document identifier, a document name, a document storage location, and/or a link to the document storage location), and provides the document association information to the first server 110 and the second server 120. Next, the task assignment device 210 generates a signing task request based on the document association information and the signer settings, and transmits it to the first server 110. Thereby, the first server 110 can cooperate with the second server 120 to complete the intelligent assessment and precisely dispatch the signing request to the designated client device 140. A user of the client device 140 can decide whether to sign based on the received document to be signed and the corresponding risk assessment information.

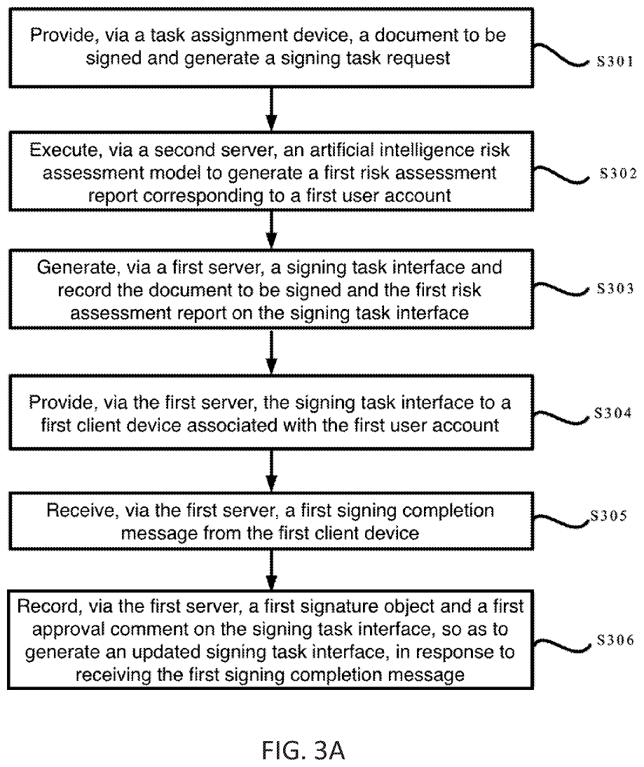

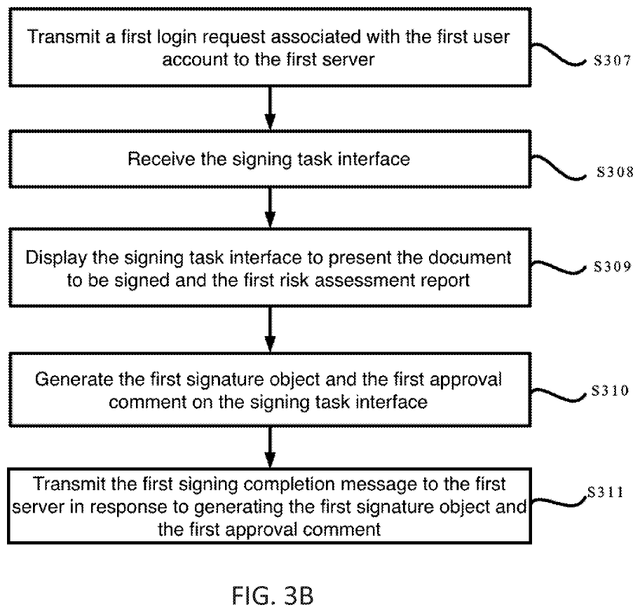

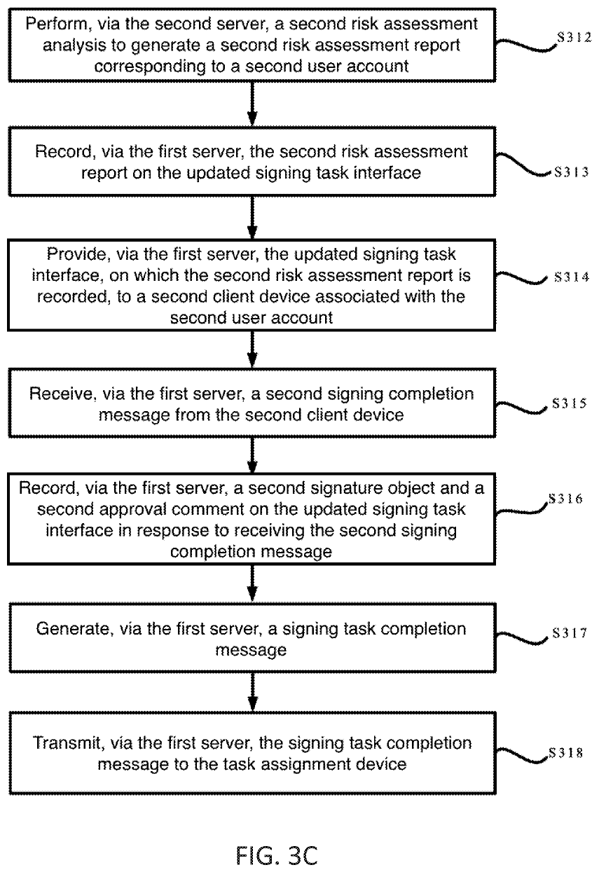

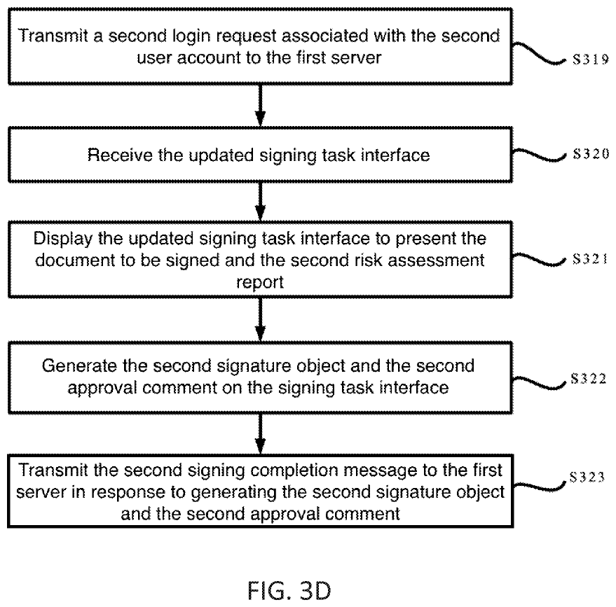

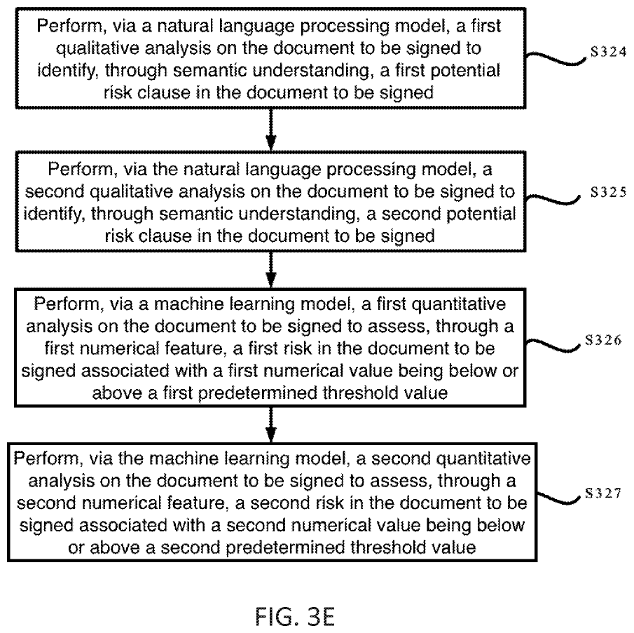

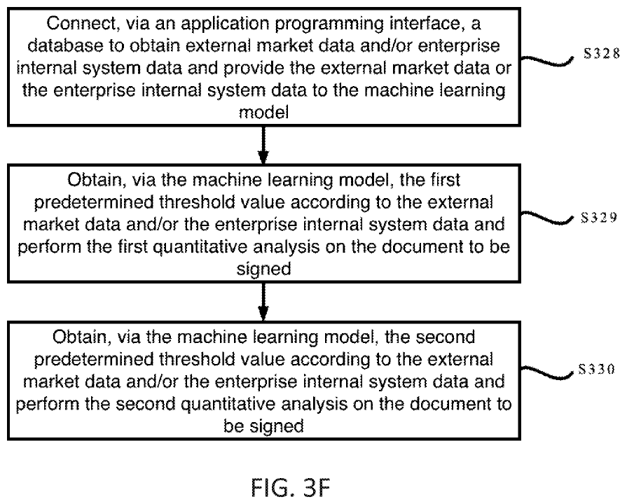

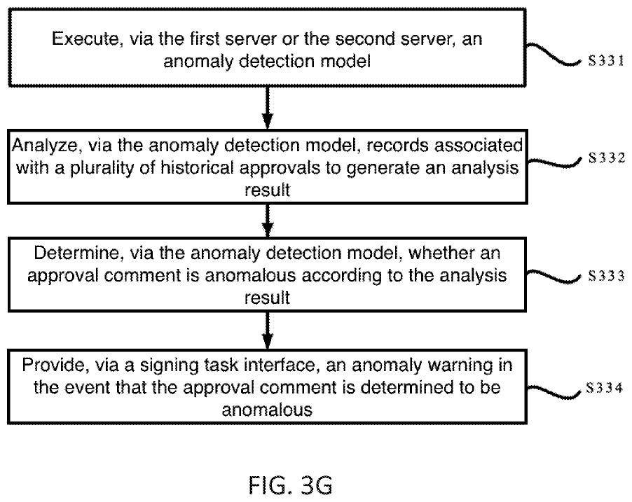

FIGS. 3A to 3G illustrate flowcharts of an intelligent signing method according to a preferred embodiment of the present invention. Referring to FIGS. 1, 2, and 3A to 3G, in step S301, a document to be signed is provided via a task assignment device 150, and a signing task request is generated according to the document to be signed. The task assignment device 150 then transmits the signing task request to a first server 110. The document to be signed may be a procurement contract, a service agreement, a non-disclosure agreement, a power of attorney, or another legal document or business document requiring multi-party approval, but the present disclosure is not limited thereto. For example, sales department personnel (the initiator) may, via their tablet computer or office workstation (i.e., the task assignment device 150), upload a “procurement contract” (i.e., the document to be signed) for a new supplier to the system provided by the first server 110, and select in the system that the contract needs to go through, in sequence, approval by the finance department and the legal department (i.e., the signing task request).

In the following embodiment, the first server 110 first transmits the document to be signed to a first client device 140-1 (for example, an electronic device used by a finance manager) for a first approval process and then transmits the document to be signed to a second client device 140-2 (for example, an electronic device used by a legal manager) for a second approval process. In addition, the first server 110 and/or the database server 130 pre-store a first user account corresponding to the first client device 140-1 and a second user account corresponding to the second client device 140-2. The first server 110 and/or the database server 130 also store a first assessment parameter associated with the first user account and a second assessment parameter associated with the second user account. For example, if the first client device 140-1 is an electronic device used by a finance manager, the first assessment parameter may include assessment criteria related to the approval role corresponding to the first user account (for example, a finance manager), such as financial risk assessment criteria for procurement amounts exceeding a certain threshold value, an annual budget cap, and/or historical average procurement price. If the second client device 140-2 is an electronic device used by a legal manager, the second assessment parameter may include assessment criteria related to the approval role corresponding to the second user account (for example, a legal manager), such as assessment criteria for the completeness of legal clauses in the contract, and/or assessment criteria for the balance of the rights and obligations of the two parties to the contract. In this embodiment, an artificial intelligence risk assessment model is installed in the second server 120.

Next, in step S302, an artificial intelligence risk assessment model is executed via the second server 120 in response to the signing task request, so as to generate a first risk assessment report corresponding to the first user account. For example, the first server 110 receives the document to be signed and the signing task request from the task assignment device 150 and transmits the signing task request and the document to be signed to the second server 120 via the communication unit 113 of the first server 110. The second server 120, in response to the signing task request, executes the artificial intelligence risk assessment model, and performs a first risk assessment analysis on the document to be signed based on the first assessment parameter, so as to generate a first risk assessment report corresponding to the first user account, and then transmits the first risk assessment report to the first server 110.

In step S303, a signing task interface is generated via the first server 110 according to the signing task request, and the document to be signed and the first risk assessment report are recorded on the signing task interface.

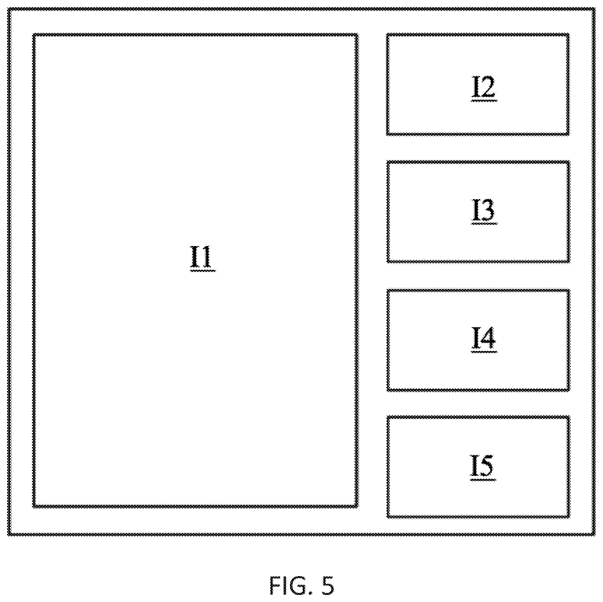

FIG. 5 is a schematic diagram illustrating the interface architecture of a signing task interface according to a preferred embodiment of the present invention. As shown in FIG. 5, the signing task interface generated by the first server 110 includes a document viewing area I1, a risk assessment report area I2, a signing operation area I3, a signing status tracking area I4, and an anomaly warning area I5. The document viewing area I1 is configured to present the full text content of the document to be signed, for the approving personnel to read and review the document content before signing. The document viewing area I1 may support functions such as document zooming, full-text search, and bookmarking, so as to enhance the reading experience of the approving personnel. The risk assessment report area I2 is configured to present a risk assessment report associated with the user account of the current approving personnel, including risk-related information generated by the artificial intelligence risk assessment model. In some embodiments, the risk assessment report area further includes a decision recommendation option, for the approving personnel to select at least one of a direct signing option, a clause modification option, or a signing termination option. The signing operation area I3 is configured for the approving personnel to generate a signature object (for example, a digital signature, an electronic seal, a signature file, or checking a signing confirmation option) on the document to be signed and to input an approval comment. The signing status tracking area I4 is configured to present the respective signing completion status of a plurality of user accounts corresponding to the signing task request, so that all personnel participating in the approval can keep track of the overall signing progress in real time. The anomaly warning area I5 is configured to display a corresponding anomaly warning in the event that an anomaly detection model identifies an anomalous approval comment, so as to alert the approving personnel to a potential anomaly. In other embodiments, the signing task interface generated by the first server 110 is not limited to one, and may be two or more, and the document viewing area I1, the risk assessment report area I2, the signing operation area I3, the signing status tracking area I4, and the anomaly warning area I5 may be respectively presented on two or more different signing task interfaces.

Specifically, in step S303, the first server 110 records and presents the document to be signed in the document viewing area I1 and records the first risk assessment report in the risk assessment report area I2.

In step S304, the signing task interface is provided via the first server 110 to a first client device 140-1 associated with the first user account. Specifically, the first server 110 provides the signing task interface, on which the document to be signed and the first risk assessment report are recorded, to the first client device 140-1.

In step S305, a first signing completion message is received from the first client device 140-1 via the first server 110. In an embodiment, the first signing completion message indicates that the first client device 140-1 has generated, on the signing task interface, a first signature object and/or a first approval comment associated with the document to be signed and the first risk assessment report.

In step S306, in response to receiving the first signing completion message, the first signature object and/or the first approval comment are recorded on the at least one signing task interface via the first server 110, so as to generate the updated signing task interface. In an embodiment, in response to receiving the first signing completion message, the first server 110 records and presents the first signature object and the first approval comment in the signing operation area I3.

In an embodiment, the intelligent signing method may, between step S304 and step S305, include steps S307 to S311 executed via the first client device 140-1, as shown in FIG. 3B.

In step S307, the first client device 140-1 transmits, via a first communication unit, a first login request associated with the first user account to the first server 110. In this embodiment, the first server 110 provides the signing task interface in response to the first login request.

In step S308, the first client device 140-1 receives the signing task interface via the first communication unit.

In step S309, the first client device 140-1 displays the signing task interface via a first display, so as to present the document to be signed and the first risk assessment report.

In step S310, the first client device 140-1 generates a first input on the signing task interface via a first input unit and generates the first signature object and the first approval comment according to the first input. Specifically, the “first input” may be, for example, the finance manager inputting comments via the first input unit (such as a keyboard, mouse, or writing tablet) to generate the first approval comment and performing signing to generate the first signature object. In other embodiments, the first client device 140-1 may generate the first signature object and/or the first approval comment according to the first input.

In step S311, the first client device 140-1, in response to generating the first signature object and the first approval comment, transmits the first signing completion message to the first server 110.

In this embodiment, the intelligent signing method may, after step S306, include step S312 executed via the second server 120 and steps S313 to S318 executed via the first server 110 (as shown in FIG. 3C), so as to carry out a second approval process by the second client device 140-2 with respect to the document to be signed.

In step S312, the artificial intelligence risk assessment model is executed via the second server 120, so as to generate a second risk assessment report corresponding to the second user account. For example, after the first server 110 generates the updated signing task interface, it transmits a command or a message associated with the second user account to the second server 120, to instruct the start of the second approval process. In response to the command or the message, the second server 120 executes the artificial intelligence risk assessment model and performs a second risk assessment analysis on the document to be signed based on the second assessment parameter, so as to generate a second risk assessment report corresponding to the second user account, and then transmits the second risk assessment report to the first server 110.

In step S313, the second risk assessment report is recorded on the updated signing task interface via the first server 110. Specifically, in step S313, the first server 110 records the second risk assessment report in the risk assessment report area I2.

In step S314, the updated signing task interface, on which the second risk assessment report is recorded, is provided via the first server 110 to a second client device 140-2 associated with the second user account. Specifically, the first server 110 provides the updated signing task interface, on which the second risk assessment report is recorded, to the second client device 140-2.

In step S315, a second signing completion message is received from the second client device 140-2 via the first server 110. In an embodiment, the second signing completion message indicates that the second client device 140-2 has generated, on the updated signing task interface, a second signature object and/or a second approval comment associated with the document to be signed and the second risk assessment report.

In step S316, in response to receiving the second signing completion message, the second signature object and/or the second approval comment are recorded on the updated signing task interface via the first server 110. In an embodiment, in response to receiving the second signing completion message, the first server 110 records and presents the second signature object and the second approval comment in the signing operation area I3.

In step S317, a signing task completion message is generated via the first server 110. Specifically, the first server 110 generates a signing task completion message in response to recording the second signature object and/or the second approval comment on the updated signing task interface.

In step S318, the signing task completion message is transmitted via the first server 110 to the task assignment device 150, so as to notify the task assignment device 150 that the entire signing process has been completed.

In an embodiment, the intelligent signing method may, between step S314 and step S315, include steps S319 to S323 executed via the second client device 140-2, as shown in FIG. 3D.

In step S319, the second client device 140-2 transmits, via a second communication unit, a second login request associated with the second user account to the first server 110. In this embodiment, the first server 110 provides the updated signing task interface in response to the second login request.

In step S320, the second client device 140-2 receives the updated signing task interface via the second communication unit.

In step S321, the second client device 140-2 displays the updated signing task interface via a second display, so as to present the document to be signed and the second risk assessment report.

In step S322, the second client device 140-2 generates a second input on the updated signing task interface via a second input unit and generates the second signature object and the second approval comment according to the second input. Specifically, the “second input” may be, for example, the legal manager inputting comments via the second input unit (such as a keyboard, mouse, or writing tablet) to generate the second approval comment and performing signing to generate the second signature object. In other embodiments, the second client device 140-2 may generate the second signature object and/or the second approval comment according to the second input.

In step S323, the second client device 140-2, in response to generating the second signature object and the second approval comment, transmits the second signing completion message to the first server 110.

In this embodiment, the artificial intelligence risk assessment model may include a natural language processing model and/or a machine learning model.

The natural language processing model is configured to perform a first qualitative analysis on the document to be signed, so as to identify, through semantic understanding, at least one first potential risk clause in the document to be signed. In this embodiment, the first risk assessment report includes the at least one first potential risk clause, and the at least one first potential risk clause is related to financial matters. For example, the natural language processing model 241 may perform the first qualitative analysis to identify, through semantic understanding, potential financial risk clauses in the document to be signed, such as payment clause risk (for example, an ambiguously defined payment trigger condition or an excessively short payment deadline), fee adjustment clause risk (for example, the counterparty having the unilateral right to raise fees), financial risk in an indemnification clause (for example, an unreasonably set indemnification cap), and risk of a missing financial safeguard mechanism (for example, the absence of a performance bond or a late-payment penalty interest clause). In this embodiment, the natural language processing model may record the identified at least one first potential risk clause and its corresponding risk explanation in the first risk assessment report, classified according to risk severity, and mark the location of each risk clause in the document to be signed, for quick location and review by the approving personnel.

The natural language processing model is further configured to perform a second qualitative analysis on the document to be signed, so as to identify, through semantic understanding, at least one second potential risk clause in the document to be signed. In this embodiment, the second risk assessment report includes the at least one second potential risk clause, and the at least one second potential risk clause is related to legal matters. For example, the natural language processing model may perform the second qualitative analysis to identify, through semantic understanding, potential legal risk clauses in the document to be signed, such as unreasonable liability-for-breach clauses (for example, unequal scope of liability or an overly broad exemption clause), jurisdiction clause risk (for example, an agreed jurisdiction unfavorable to one's own party or unclear arbitration procedural rules), confidentiality obligation and intellectual property clause risk (for example, an overly broad definition of the scope of confidentiality or unclear agreement on the ownership of intellectual property rights), and termination clause risk (for example, the counterparty having the unilateral right to terminate at will). In this embodiment, the natural language processing model may record the identified at least one second potential risk clause and its corresponding risk explanation in the second risk assessment report, classified according to risk severity, and mark the location of each risk clause in the document to be signed, for quick location and review by the approving personnel.

The machine learning model is configured to perform a first quantitative analysis on the document to be signed, so as to assess, through a first numerical feature, at least one first risk in the document to be signed associated with at least one first numerical value being below or above a first predetermined threshold value. In this embodiment, the first risk assessment report includes the at least one first risk, and the at least one first risk is related to legal matters. For example, the machine learning model may perform the first quantitative analysis to assess, through the first numerical feature, whether a legal risk numerical indicator in the document to be signed, such as a clause obligation imbalance index (for example, the ratio of the number and stringency of the obligation clauses borne by both parties in the contract), a breach clause coverage rate, and a completeness score of a dispute resolution clause, exceeds a first predetermined threshold value, so as to quantify the degree of legal risk of the document to be signed. In this embodiment, the first predetermined threshold value may be determined according to a risk threshold parameter set in the first assessment parameter and may be dynamically adjusted according to internal enterprise regulations, industry standards, or external market data.

The machine learning model is further configured to perform a second quantitative analysis on the document to be signed, so as to assess, through a second numerical feature, at least one second risk in the document to be signed associated with at least one second numerical value being below or above a second predetermined threshold value. In this embodiment, the second risk assessment report includes the at least one second risk, and the at least one second risk is related to financial matters. For example, the machine learning model may perform the second quantitative analysis to assess, through the second numerical feature, whether a financial risk numerical indicator, such as whether the contract amount exceeds the budget cap, whether the prepayment ratio is too high, whether the payment deadline is too short, and whether the fee adjustment range exceeds an acceptable range, exceeds a predetermined threshold value, so as to quantify the degree of financial risk of the document to be signed. In this embodiment, the second predetermined threshold value may be determined according to a risk threshold parameter set in the second assessment parameter and may be dynamically adjusted according to internal enterprise regulations, industry standards, or external market data.

In an embodiment, the machine learning model may record the identified at least one first risk and its corresponding risk quantification indicator in the first risk assessment report and record the identified at least one second risk and its corresponding risk quantification indicator in the second risk assessment report. In another embodiment, the machine learning model may integrate the results of the above qualitative analysis and the above quantitative analysis, and, based on the decision criteria set in the first assessment parameter and the decision criteria set in the second assessment parameter, provide a corresponding decision recommendation option, including at least one of a direct signing option, a clause modification option, or a signing termination option, for reference by the approving personnel on the signing task interface, so as to assist in generating the first approval comment and the second approval comment.

In an embodiment, the database server 130 further stores a plurality of feature vectors associated with a plurality of historical contracts. The artificial intelligence risk assessment model, based on the document to be signed, utilizes a Retrieval-Augmented Generation (RAG) technique to retrieve, from among the feature vectors, feature vectors associated with the document to be signed, and, based on the retrieved associated feature vectors, assists in generating the first risk assessment report and the second risk assessment report. Through the RAG technique, the artificial intelligence risk assessment model is able to reference the approval outcomes and risks of similar past contracts, thereby providing a more targeted and accurate risk assessment report.

In addition, the intelligent signing method may include steps S324-S325 executed via the natural language processing model and/or steps S326-S327 executed via the machine learning model, as shown in FIG. 3E.

In step S324, a first qualitative analysis is performed on the document to be signed via the natural language processing model, so as to identify, through semantic understanding, a first potential risk clause in the document to be signed.

In step S325, a second qualitative analysis is performed on the document to be signed via the natural language processing model, so as to identify, through semantic understanding, a second potential risk clause in the document to be signed.

In step S326, a first quantitative analysis is performed on the document to be signed via the machine learning model, so as to assess, through a first numerical feature, a first risk in the document to be signed associated with a first numerical value being below or above a first predetermined threshold value.

In step S327, a second quantitative analysis is performed on the document to be signed via the machine learning model, so as to assess, through a second numerical feature, a second risk in the document to be signed associated with a second numerical value being below or above a second predetermined threshold value.

In an embodiment, the machine learning model may connect, via an Application Programming Interface (API), to at least one external database to obtain external market data and/or enterprise internal system data, and dynamically update the first predetermined threshold value and the second predetermined threshold value according to such data, so as to ensure that the results of the above quantitative analysis reflect the current market environment and the financial condition of the enterprise.

In an embodiment, the intelligent signing method may further include steps S328 to S330 executed by the machine learning model in the second server, as shown in FIG. 3F.

In step S328, at least one database is connected via an application programming interface, so as to obtain external market data and/or enterprise internal system data, and the external market data or the enterprise internal system data is provided to the machine learning model.

In step S329, the first predetermined threshold value is obtained via the machine learning model according to the external market data and/or the enterprise internal system data, and the first quantitative analysis is performed on the document to be signed.

In step S330, the second predetermined threshold value is obtained via the machine learning model according to the external market data and/or the enterprise internal system data, and the second quantitative analysis is performed on the document to be signed.

In an embodiment, one of the first server 110 and the second server 120 has installed an anomaly detection model configured to identify an anomalous approval comment and provide a warning.

In an embodiment, the intelligent signing method may further include steps S331 to S334 executed by the first server 110 or the second server 120, as shown in FIG. 3G.

In step S331, an anomaly detection model is executed via the first server 110 or the second server 120.

In step S332, records associated with a plurality of historical approvals are analyzed via the anomaly detection model, so as to generate an analysis result. Specifically, the anomaly detection model analyzes a plurality of historical approval records stored in the database server 130, so as to establish a baseline model of normal approval behavior. The historical approval records may include information such as the approval time, the approval decision (approve/reject/request modification), the text content of the approval comment, and characteristics of the signature object of the approving personnel. The anomaly detection model may, through statistical analysis or a machine learning method, extract a feature distribution of normal approval behavior from the historical approval records, and generate an analysis result.

In step S333, whether an approval comment (for example, the aforementioned first approval comment or second approval comment) is anomalous is determined via the anomaly detection model according to the analysis result. Specifically, the anomaly detection model may determine, according to the analysis result, whether the approval comment is anomalous. For example, if the time at which the approval comment was generated differs excessively from the approving personnel's past average approval time (for example, completing, in an extremely short time, the approval of a complex contract that would normally require careful review), or if the text content of the approval comment differs significantly from the approving personnel's past approval comment style, the anomaly detection model will flag the approval comment as a potential anomaly.

In step S334, in the event that the approval comment is determined to be anomalous, an anomaly warning is provided via a signing task interface. Specifically, in the event that the anomaly detection model determines that the approval comment is anomalous, the anomaly detection model provides an anomaly warning via the anomaly warning area I5 of the signing task interface, to alert subsequent approving personnel to the potential anomaly, so as to ensure the reliability and security of the approval process.

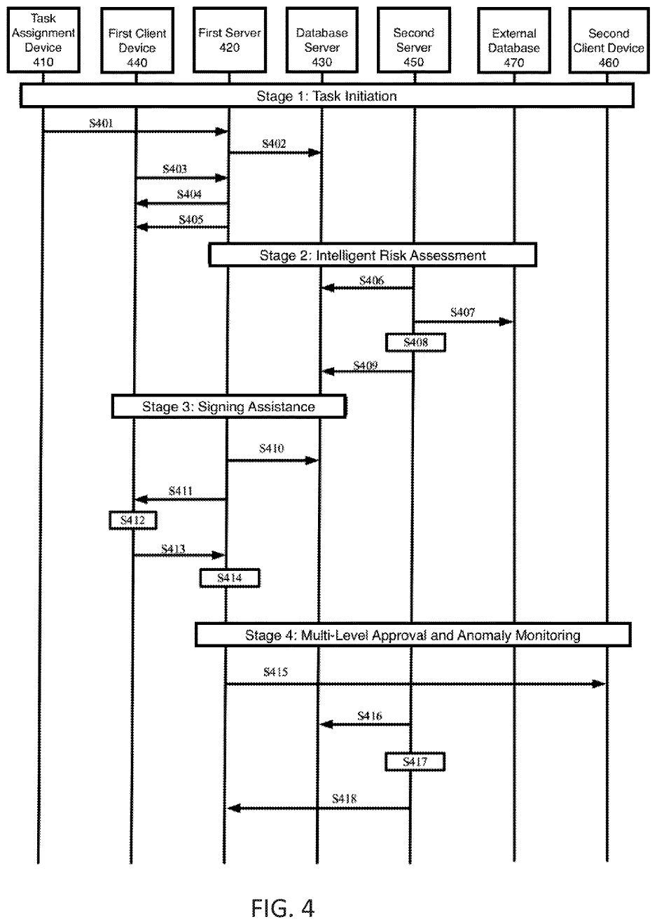

FIG. 4 is a sequence diagram of an intelligent signing method according to a preferred embodiment of the present invention. Referring to FIG. 4, and in conjunction with the technical features of all the aforementioned claims, this embodiment discloses in detail the signal transmission and data flow between the system components.

In step S401, a document to be signed and a signing task request are transmitted from a task assignment device 410 to a first server 420. In step S402, after receiving them, the first server 420 uploads the document to be signed to a database server 430 for storage, wherein the database server 430 pre-stores assessment parameters corresponding to different specific approval roles (for example, a finance manager and a legal manager) and different user accounts associated with the different specific approval roles (for example, a first user account and a second user account). In step S403, a first client device 440 associated with the first user account transmits a first login request to the first server 420. In step S404, the first server 420 grants approval authority associated with the first user account to the first client device 440 according to the first login request, and, in step S405, generates a signing task interface based on the signing task request and the first user account, and transmits it to the first client device 440.

In the risk assessment stage, in step S406, a second server 450 obtains the document to be signed and a first assessment parameter from the database server 430. In order to improve the accuracy of the analysis, the second server 450 further utilizes a Retrieval-Augmented Generation (RAG) technique to retrieve, from the database server 430, feature vectors of associated historical contracts based on the document to be signed. Meanwhile, in step S407, the first server 420 or the second server 450 may connect, via an Application Programming Interface (API), to an external database 470, so as to obtain external market data or enterprise internal system data and provide it to the second server 450. Next, in step S408, the second server 450 initiates an artificial intelligence risk assessment model and performs a first risk assessment analysis on the document to be signed based on the first assessment parameter. Specifically, the first risk analysis includes performing a qualitative analysis based on a natural language processing model to identify potential risk clauses, and performing a quantitative analysis based on a machine learning model to assess the degree of risk. Subsequently, in step S409, the second server 450 generates a first risk assessment report corresponding to the first user account and uploads it to the database server 430.

In the signing assistance and execution stage, in step S410, the first server 420 receives the first risk assessment report from the database server 430, and, in step S411, records the first risk assessment report together with the document to be signed on the signing task interface, so as to provide it to the first client device 440. In step S412, the first client device 440 presents the first risk assessment report and the document to be signed, wherein the first risk assessment report further includes at least one decision recommendation option (including at least one of a direct signing option, a clause modification option, and a signing termination option). The first client device 440 receives a first input from a user to generate a first signature object and a first approval comment on the signing task interface and generates a first signing completion message. In step S413, the first client device 440 transmits the first signing completion message to the first server 420. After receiving the first signing completion message in step S414, the first server 420 records the first signature object and the first approval comment on the signing task interface, so as to generate the updated signing task interface.

In order to achieve multi-tier and continuous monitoring, in step S415, in response to generating the updated signing task interface, the first server 420 determines a subsequent approval role (for example, legal personnel) based on the signing task request and transmits the updated signing task interface to a second client device 460 associated with the second user account. In step S416, the second server 450 performs a second risk assessment analysis on the document to be signed based on a second assessment parameter corresponding to the subsequent approval role, so as to generate a second risk assessment report corresponding to the second user account, and uploads it to the database server 430. In addition, in steps S417 and S418, the second server 450 may execute an anomaly detection model to analyze a plurality of historical approval records in the database server 430, so as to determine whether the approval comments generated by the first client device 440 and the second client device 460 are anomalous, and, in the event that the first approval comment is determined to be anomalous, issue an anomaly warning to the first server 420, such that the first server 420 can record the anomaly warning on the signing task interface, so as to provide the anomaly warning via the signing task interface, thereby ensuring the security and defensibility of the overall intelligent signing system.

It should be noted that the sequence diagram illustrated in FIG. 4 is a comprehensive preferred embodiment, provided to concretely demonstrate the maximum expandability of the system and complete data flow. However, one of ordinary skill in the art should understand that some of the steps in the figure are of an “optional design” and are not absolutely necessary steps. In actual system deployment and practical application, these non-essential steps may be flexibly omitted or dynamically skipped according to the nature of the “document to be signed” and the specific needs of the enterprise.

For example, the operation in step S407 of obtaining external market data or enterprise internal system data via an application programming interface (API) is not necessary in certain specific signing scenarios. When the “document to be signed” is an internal “employee non-disclosure agreement (NDA),” a “leave request form,” or an “internal IT equipment request form,” the system need only rely on the company's internal standard norms to perform the review, without any need to retrieve a supplier's credit rating, customs information, or external market quotation data. In such a case, the system architecture directly skips step S407, and the second server 450 performs the risk assessment analysis based solely on the “assessment parameter” already existing in the database server. This flexible design can substantially save the computational resources of the system and network bandwidth.

Similarly, the step of “utilizing a Retrieval-Augmented Generation (RAG) technique to retrieve feature vectors of historical contracts” in step S406 is likewise an optional design. If the document to be signed uploaded by the initiator is a “standard form contract” that is highly standardized, has fixed terms, and has no historical flexibility, the second server need only initiate the intelligent risk assessment engine to perform routine natural language comparison, without needing to consume additional GPU computing power to search a vector database for past signing trajectories.

In addition, the background monitoring mechanism in steps S417 and S418 of “executing an anomaly detection model to dynamically issue an anomaly warning,” although it can substantially enhance the enterprise's defensibility, is also an advanced, optional information-security feature. For a small or medium-sized enterprise that only requires simple contract risk alerts, even with the anomaly detection model removed or disabled, the first server 420 and the second server 450 can still successfully complete the core process from task assignment, through risk assessment, to finally obtaining the signed document.

Accordingly, the system architecture of the present invention has a high degree of modularity and configuration flexibility. Steps in FIG. 4 such as obtaining external data, retrieving historical feature vectors, and anomaly monitoring are all variant examples that enrich the functionality of the system, and should not be used to limit the scope of the patent of the core independent claims of the present invention.

In summary, a preferred embodiment of the present invention adopts a multi-tier intelligent signing system that integrates qualitative analysis via natural language processing with quantitative simulation via a machine learning model. By automatically linking heterogeneous databases internal and external to the enterprise, and introducing a Retrieval-Augmented Generation technique to precisely compare historical contract characteristics with market data, and dynamically configuring dedicated assessment parameters for different reviewing departments, the system is able to, during the contract review process, automatically and comprehensively detect legal loopholes and financial cash-flow anomalies hidden within a document to be signed, and in turn generate, in real time, a risk assessment report and decision recommendations including specific operational options (such as directly signing, modifying terms, or returning the document). This not only thoroughly breaks the time delays and information-silo problems caused by conventional approval processes being highly dependent on manual work, and significantly reduces the review burden on professionals such as legal, finance, and procurement personnel, but also, through precise decision-assistance options, effectively improves the overall accuracy and execution efficiency of the approval process, thereby constructing, for the enterprise, a decision management architecture with low operational risk and a high degree of defensibility.

The specific embodiments set forth in the detailed description of the preferred embodiments are provided only to facilitate the description of the technical content of the present invention and are not intended to narrowly limit the present invention to the above embodiments. Various modifications made without departing from the spirit of the present invention and the scope of the claims below all fall within the scope of the present invention. Accordingly, the scope of protection of the present invention shall be defined by the appended claims.

What is claimed is:

1. An intelligent signing system, comprising:
a task assignment device configured to provide a document to be signed and generate a signing task request according to the document to be signed; and
at least one server storing a first user account and a first assessment parameter associated with the first user account, wherein the at least one server is configured to:
receive the signing task request from the task assignment device;
execute, in response to the signing task request, an artificial intelligence risk assessment model and perform a first risk assessment analysis on the document to be signed based on the first assessment parameter, so as to generate a first risk assessment report corresponding to the first user account;
generate, according to the signing task request, at least one signing task interface and record the document to be signed and the first risk assessment report on the at least one signing task interface;
provide the at least one signing task interface, on which the document to be signed and the first risk assessment report are recorded, to a first client device associated with the first user account;
receive a first signing completion message from the first client device, wherein the first signing completion message indicates that the first client device has generated, on the at least one signing task interface, at least one of a first signature object and a first approval comment associated with the document to be signed and the first risk assessment report; and
record, in response to receiving the first signing completion message, at least one of the first signature object and the first approval comment on the at least one signing task interface, so as to generate at least one updated signing task interface.

2. The intelligent signing system of claim 1, further comprising the first client device, wherein:
the first client device comprises a first communication unit, a first display, and a first input unit and is configured to:
transmit, via the first communication unit, a first login request associated with the first user account to the at least one server, wherein the at least one server is further configured to provide the at least one signing task interface in response to the first login request;
receive the at least one signing task interface via the first communication unit;
display the at least one signing task interface via the first display to present the document to be signed and the first risk assessment report;
generate, via the first input unit, a first input on the at least one signing task interface and generate at least one of the first signature object and the first approval comment according to the first input; and
transmit the first signing completion message to the at least one server in response to generating at least one of the first signature object and the first approval comment.

3. The intelligent signing system of claim 1, further comprising a second client device, wherein:
the at least one server further stores a second user account and a second assessment parameter associated with the second user account;
the second client device is associated with the second user account; and
the at least one server is further configured to:
execute the artificial intelligence risk assessment model and perform a second risk assessment analysis on the document to be signed based on the second assessment parameter, so as to generate a second risk assessment report corresponding to the second user account;
record the second risk assessment report on the at least one updated signing task interface; and
provide the at least one updated signing task interface, on which the second risk assessment report is recorded, to the second client device.

4. The intelligent signing system of claim 3, wherein, after providing the at least one updated signing task interface to the second client device, the at least one server is further configured to:
receive a second signing completion message from the second client device, wherein the second signing completion message indicates that the second client device has generated, on the at least one updated signing task interface, at least one of a second signature object and a second approval comment associated with the document to be signed and the second risk assessment report; and
record, in response to receiving the second signing completion message, at least one of the second signature object and the second approval comment on the at least one updated signing task interface.

5. The intelligent signing system of claim 4, wherein, after providing the at least one updated signing task interface to the second client device, the at least one server is further configured to:
generate a signing task completion message in response to recording at least one of the second signature object and the second approval comment on the at least one updated signing task interface; and
transmit the signing task completion message to the task assignment device.

6. The intelligent signing system of claim 1, wherein the artificial intelligence risk assessment model comprises:
a natural language processing model configured to perform a qualitative analysis on the document to be signed to identify, through semantic understanding, at least one first potential risk clause in the document to be signed, wherein the first risk assessment report comprises the at least one first potential risk clause.

7. The intelligent signing system of claim 1, wherein the artificial intelligence risk assessment model comprises:
a machine learning model configured to perform a quantitative analysis on the document to be signed to assess, through a numerical feature, at least one risk in the document to be signed associated with at least one numerical value being below or above a predetermined threshold value, wherein the first risk assessment report comprises the at least one risk.

8. The intelligent signing system of claim 7, wherein the at least one server is further configured to:
connect, via an application programming interface (API), to at least one database to obtain external market data or enterprise internal system data and provide the external market data or the enterprise internal system data to the machine learning model; and
obtain, via the machine learning model, the predetermined threshold value according to the external market data or the enterprise internal system data and perform the quantitative analysis on the document to be signed.

9. The intelligent signing system of claim 1, wherein the at least one server further stores at least one feature vector associated with a plurality of historical contracts and is further configured to:
retrieve the at least one feature vector using a retrieval-augmented generation (RAG) technique based on the document to be signed, wherein the first risk assessment report is generated based on the at least one feature vector.

10. The intelligent signing system of claim 1, wherein the first risk assessment report further comprises at least one of a direct signing option, a clause modification option, or a signing termination option.

11. The intelligent signing system of claim 1, wherein:
the at least one server is further configured to execute an anomaly detection model; and
the anomaly detection model is configured to:
analyze records associated with a plurality of historical approvals to generate an analysis result;
determine, according to the analysis result, whether the first approval comment is anomalous; and
provide an anomaly warning via the at least one signing task interface in the event that the first approval comment is determined to be anomalous.

12. A method for intelligent signing, comprising:
providing, via a task assignment device, a document to be signed and generating a signing task request according to the document to be signed; and
executing, via at least one server, the following steps:
executing, in response to the signing task request, an artificial intelligence risk assessment model and performing a first risk assessment analysis on the document to be signed based on a first assessment parameter, so as to generate a first risk assessment report corresponding to a first user account;
generating, according to the signing task request, at least one signing task interface and recording the document to be signed and the first risk assessment report on the at least one signing task interface;
providing the at least one signing task interface, on which the document to be signed and the first risk assessment report are recorded, to a first client device associated with the first user account;
receiving a first signing completion message from the first client device, wherein the first signing completion message indicates that the first client device has generated, on the at least one signing task interface, at least one of a first signature object and a first approval comment associated with the document to be signed and the first risk assessment report; and
recording, in response to receiving the first signing completion message, at least one of the first signature object and the first approval comment on the at least one signing task interface, so as to generate at least one updated signing task interface.

13. The method of claim 12, wherein the first client device comprises a first communication unit, a first display, and a first input unit, and the method further comprises executing, via the first client device, the following steps:
transmitting, via the first communication unit, a first login request associated with the first user account to the at least one server, wherein the at least one server provides the at least one signing task interface in response to the first login request;
receiving the at least one signing task interface via the first communication unit;
displaying the at least one signing task interface via the first display to present the document to be signed and the first risk assessment report;
generating, via the first input unit, a first input on the at least one signing task interface and generating at least one of the first signature object and the first approval comment according to the first input; and
transmitting the first signing completion message to the at least one server in response to generating at least one of the first signature object and the first approval comment.

14. The method of claim 12, further comprising executing, via the at least one server, the following steps:
executing the artificial intelligence risk assessment model and performing a second risk assessment analysis on the document to be signed based on a second assessment parameter, so as to generate a second risk assessment report corresponding to a second user account;
recording the second risk assessment report on the at least one updated signing task interface; and
providing the at least one updated signing task interface, on which the second risk assessment report is recorded, to a second client device associated with the second user account.

15. The method of claim 14, further comprising, after providing the at least one updated signing task interface to the second client device, executing, via the at least one server, the following steps:
receiving a second signing completion message from the second client device, wherein the second signing completion message indicates that the second client device has generated, on the at least one updated signing task interface, at least one of a second signature object and a second approval comment associated with the document to be signed and the second risk assessment report; and
recording, in response to receiving the second signing completion message, at least one of the second signature object and the second approval comment on the at least one updated signing task interface.

16. The method of claim 15, further comprising executing, via the at least one server, the following steps:
generating a signing task completion message in response to recording at least one of the second signature object and the second approval comment on the at least one updated signing task interface; and
transmitting the signing task completion message to the task assignment device.

17. The method of claim 12, wherein the artificial intelligence risk assessment model comprises a natural language processing model, and the method comprises:
performing, via the natural language processing model, a qualitative analysis on the document to be signed to identify, through semantic understanding, at least one first potential risk clause in the document to be signed, wherein the first risk assessment report comprises the at least one first potential risk clause.

18. The method of claim 12, wherein the artificial intelligence risk assessment model comprises a machine learning model, and the method comprises:
performing, via the machine learning model, a quantitative analysis on the document to be signed to assess, through a numerical feature, at least one risk in the document to be signed associated with at least one numerical value being below or above a predetermined threshold value, wherein the first risk assessment report comprises the at least one risk.

19. The method of claim 18, further comprising executing, via the at least one server, the following steps:
connecting, via an application programming interface (API), to at least one database to obtain external market data or enterprise internal system data and providing the external market data or the enterprise internal system data to the machine learning model; and
obtaining, via the machine learning model, the predetermined threshold value according to the external market data or the enterprise internal system data and performing the quantitative analysis on the document to be signed.

20. The method of claim 12, further comprising:
executing, via the at least one server, an anomaly detection model; and
executing, via the anomaly detection model, the following steps:
analyzing records associated with a plurality of historical approvals to generate an analysis result;
determining, according to the analysis result, whether the first approval comment is anomalous; and
providing an anomaly warning via the at least one signing task interface in the event that the first approval comment is determined to be anomalous.
